(19) United States
(12) Patent Application Publication
(10) Pub. No.: US 2026/0277279 A1
(43) Pub. Date: Sep. 17, 2026

(54) MULTI-AXIS PIN JOINT HINGE

(71) Applicant: Microsoft Technology Licensing, LLC, Redmond, WA (US)

(72) Inventor: Nicholas Benjamin WENDT, South Bend, IN (US)

(21) Appl. No.: 19/081,276

(22) Filed: Mar. 17, 2025

(51) Int. Cl. G06F 1/16; F16M 13/00

(52) U.S. Cl. CPC G06F 1/1681; F16M 13/005; G06F 1/1626; G06F 1/166

(57) ABSTRACT

Laptop or tablet computing devices may utilize various hinge types and styles to connect a display component with a keyboard component of a laptop or a kickstand or other accessory to a tablet. Presenting a continuous visual impression to the user suggests a higher overall quality of the computing device and is thus desirable. The presently disclosed multi-axis pin joint hinge both hides aspects of the hinge and maintains a minimal and consistent gap between connected components. The hinge includes a trio of pin joints that connect first and second links to a tablet and a kickstand, for example. As each pin joint rotates through the range of motion of the hinge, pivot axes all remain intersecting with a point coincident with the rotation axis. As a result, the rotation axis remains in a fixed position throughout the range of motion of the hinge.

### BACKGROUND

Computing devices encompass a variety of devices that can be programmed to carry out one or more specific sets of arithmetic and/or logical operations, with or without user input. Some computing devices utilize one or more hinges to pivotally connect two or more components of the computing device. This may be a display and a base in a laptop computing device or a body and kickstand in a tablet or mobile computing device, as examples. Conventionally, such computing device hinges often take the form of a barrel hinge (including a continuous hinge) or for recent devices, concealed hinges with sliding bearing components.

### SUMMARY

Implementations described and claimed herein provide a multi-axis pin joint hinge comprising a first link, a second link, and three pin joints. The first pin joint connects the first link to a first hinged component. The first pin joint is rotatable about a first pivot axis. The second pin joint connects the first link to the second link. The second pin joint is rotatable about a second pivot axis. The third pin joint connects the second link to a second hinged component. The third pin joint is rotatable about a third pivot axis. The hinge permits the first hinged component to rotate relative to the second hinged component about a rotation axis. The first, second, and third pivot axes intersect at a first point on the rotation axis.

Implementations described and claimed herein further provide a method of rotating a first device component relative to a second device component of a computing device about a rotation axis using a multi-axis pin joint hinge. The method comprises rotating a first pin joint connecting a first link to the first device component about a first pivot axis, rotating a second pin joint connecting the first link to a second link about a second pivot axis, and rotating a third pin joint connecting the second link to the second device component about a third pivot axis. The first, second, and third pivot axes intersect at a first point on the rotation axis.

Implementations described and claimed herein still further provide a computing device comprising a first device component, a second device component, and a first hinge connecting the first device component to the second device component. The first hinge permits the first device component to rotate relative to the second device component about a rotation axis. The first hinge includes a first link, a second link, and three pin joints. The first pin joint connects the first link to the first device component. The first pin joint is rotatable about a first pivot axis. The second pin joint connects the first link to the second link. The second pin joint is rotatable about a second pivot axis. The third pin joint connects the second link to the second device component. The third pin joint is rotatable about a third pivot axis. The first, second, and third pivot axes intersect at a first point on the rotation axis.

Other implementations are also described and recited herein. This Summary is provided to introduce a selection of concepts in a simplified form that are further described below in the Detailed Descriptions. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a rear perspective view of an example computing device including an integral kickstand deployed and connected to a tablet using a pair of multi-axis pin joint hinges.

FIG. 2 illustrates a rear perspective view of an example computing device including an integral kickstand stowed against a tablet and connected to the tablet using a pair of multi-axis pin joint hinges.

FIG. 3 illustrates a perspective view of an example multi-axis pin joint hinge.

FIG. 4A illustrates a perspective view of an example multi-axis pin joint hinge in a fully closed orientation.

FIG. 4B illustrates the example multi-axis pin joint hinge of FIG. 4A in a mostly closed orientation.

FIG. 5A illustrates the example multi-axis pin joint hinge of FIG. 4A in a mostly open orientation.

FIG. 5B illustrates the example multi-axis pin joint hinge of FIG. 4A in a fully open orientation.

FIG. 6 illustrates example operations for using a multi-axis pin joint hinge.

### DETAILED DESCRIPTION

A conventional hinged connection between computing device components typically utilizes a pair of barrel hinges located at or near endpoints of the hinged connection. The conventional hinged connection may alternatively be a long continuous hinge occupying most or all of the hinged connection between the hinged components. With either conventional style, the hinge(s) is visibly contiguous with one of the computing device components, and rotatable with regard to the other of the computing device components. The hinge is visible to the user and a visible gap may be visible between barrel hinges. These visible hinge features and gaps yield a discontinuous visual impression of the computing device to a user.

Conventional concealed hinges with sliding bearing components resolve some shortcomings of barrel and continuous hinges, in particular hiding the hinge components within the computing device housing. Further, concealed hinges with sliding bearing components yield a minimized gap between the computing device components that can be maintained throughout a range of angular motion of the concealed hinges with sliding bearing components. However, such concealed hinges often adopt a complex and intricate design with separate components for defining motion and friction constraints. These concealed hinges are complex to manufacture, and the sliding bearing components are susceptible to wear, thereby reducing the hinge's effectiveness and perceived quality over time.

The presently disclosed multi-axis pin joint hinges maintain some advantages of concealed hinges with sliding bearing components, such as concealed hinge components and a minimized and consistent gap between the computing device components. In addition, the presently disclosed multi-axis pin joint hinges maintain a large operating range of at least 135-degrees, which is comparable to many barrel or continuous hinges, as well as many concealed hinges with sliding bearing components.

The multi-axis pin joint hinges adopt a simplified design as compared with concealed hinges with sliding bearing components. The multi-axis pin joint hinges include generally fewer components, with pin joints in place of separate components for defining motion and friction constraints. This is technically advantageous in that achieving a similar result with fewer components generally yields a more durable and reliable product. As the presently disclosed multi-axis pin joint hinges utilize pin joints in place of sliding joints, the presently disclosed technology obtains the general advantages of pin joints over sliding joints. Namely, that pin joints are ideal for precision, reliability, and simplicity, particularly when compared with sliding joints. Pin joints are also technically advantageous in that they can provide a precise and consistent friction constraint over a long duty cycle, particularly as compared to sliding bearings. Further, the multi-axis pin joint hinges reduce part count over conventional concealed hinges with sliding bearing components by using one of the computing device components (e.g., the kickstand) as one of the links in the mechanism. In various implementations, the multi-axis pin joint hinges may have a smaller packaging requirement within the computing device as compared to a concealed hinges with sliding bearing components with comparable performance. This is technically advantageous in that space is nearly universally at a premium within portable computing devices.

Pin joints as used herein include any two structures connected with a knuckle with a pin running therethrough. The knuckle and pin combination is used to create freedom of rotation about the pin axis. Similar hinged structures that achieve a freedom of rotation about a central axis are also contemplated herein and intended to be covered by the recited pin joints.

Laptop or tablet computing devices may utilize barrel or continuous hinges or concealed hinges with sliding bearing components, for example, to connect a display component with a keyboard component of a laptop or a kickstand or other accessory to a tablet. Other computing devices may have a similar configuration with two components connected via one or more hinges. In all computing devices, presenting a continuous visual impression to the user suggests a higher overall quality of the computing device to the user, and is thus desirable. The presently disclosed technology both hides aspects of the multi-axis pin joint hinge and maintains a minimal gap between connected components that is consistent throughout a range of motion of the multi-axis pin joint hinge.

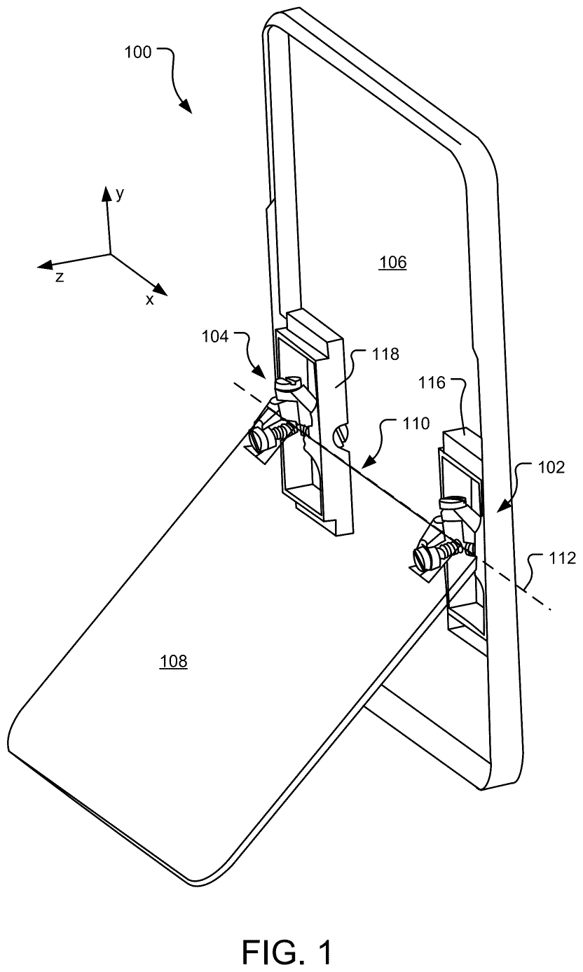

XYZ coordinates are shown in the FIGS. 1-3 and described below to illustrate directional features of the disclosed technology. Other coordinate systems may also be used with different orientations with similar effect. Further, some features are illustrated herein in broken lines. These features would not normally be visible from an exterior of a computing device, other device, or hinged components described herein, and/or may appear far different from the depictions in FIGS. 1-3 but are nonetheless shown to illustrate the disclosed technology.

FIG. 1 illustrates a rear perspective view of an example computing device 100 including an integral kickstand 108 deployed and connected to a tablet 106 using a pair of multi-axis pin joint hinges 102, 104. The hinges 102, 104 each pivotally connect the tablet 106 (or a first device component) with the integral kickstand 108 (or a second device component) of the device 100. As a result, a user may position the kickstand 108 at a variety of angles with respect to the tablet 106 to achieve a desired viewing angle to the tablet 106, or for other user considerations. The kickstand 108 is illustrated as transparent and a rear cover of the tablet 106 is omitted to better illustrate the hinges 102, 104.

The hinges 102, 104 each include a trio of pin joints that connect first and second links to the tablet 106 and the kickstand 108. Pivot axes corresponding to each of the pin joints intersect at a point coincident with rotation axis 112. The rotation axis 112 represents the instant center of the hinges 102, 104, which may project in free space between the tablet 106 and the kickstand 108. As each pin joint rotates through the range of motion of the hinges 102, 104, the pivot axes all remain intersecting on a point coincident with the rotation axis 112. As a result, the rotation axis 112 remains in a fixed position and a hinge gap between the tablet 106 and the integral kickstand 108 is consistent throughout the range of motion of the hinges 102, 104. This is technically advantageous in that it allows for the hinge gap to be minimized in the computing device 100.

In various implementations herein, the hinges 102, 104 are referred to separately as hinges or collectively as a singular hinge. The hinges 102, 104 are connected to the tablet 106 at frames 116, 118, respectively, each of which also serves as a cavity in the tablet 106. These cavities house a portion of the hinges 102, 104 in the depicted deployed configuration of the kickstand 108. Other implementations may omit the frames 116, 118 and instead connect the hinges 102, 104 directly to the tablet 106. There still may be cavities in the tablet 106 to house the hinges 102, 104 in the absence of the frames 116, 118. This may be technically advantageous in reducing added part count for implementing the hinges 102, 104.

The hinges 102, 104 each partially constrain motion of the kickstand 108 to rotation about the rotation axis 112 extending in the x-direction. The hinges 102, 104 individually do not constrain rotation of the kickstand 108 about the pivot axes that connects to the kickstand 108 (generally, but not exactly in the z-direction, as this varies depending on the position of the kickstand 108). However, in combination, the hinges 102, 104 further constrain rotation of the kickstand 108 about the pivot axes that connect to the kickstand 108. Therefore, in combination the hinges 102, 104 constrain motion of the kickstand 108 to rotation about the rotation axis 112 only. Other implementations may use more than the two hinges 102, 104, but only one of the hinges 102, 104 may yield an under constrained system.

An edge of the kickstand 108 abuts the tablet 106 at abutting interface 110. The hinges 102, 104 are designed to pivot about the rotation axis 112 running parallel and coincident with the abutting interface 110 in the x-direction. By making the rotation axis 112 parallel and coincident with the abutting interface 110, the abutting edge of the kickstand 108 remains in position on the tablet 106 throughout a rotational range of motion (or operating range) of the kickstand 108 with reference to the tablet 106 (e.g., approximately 0 -150 degrees). Abutting within the context of the present application includes physical contact and near physical contact (e.g., less than a 1 mm hinge gap). Variations of the hinge gap within the rotational range of motion of the hinges 102, 104 may be caused by manufacturing variations, but remain within applicable tolerances (e.g., +/−0.1 mm of the hinge gap). The resulting visual impression to the user is that the kickstand 108 is contiguous or nearly contiguous with the tablet 106 throughout the rotational range of motion of the hinges 102, 104.

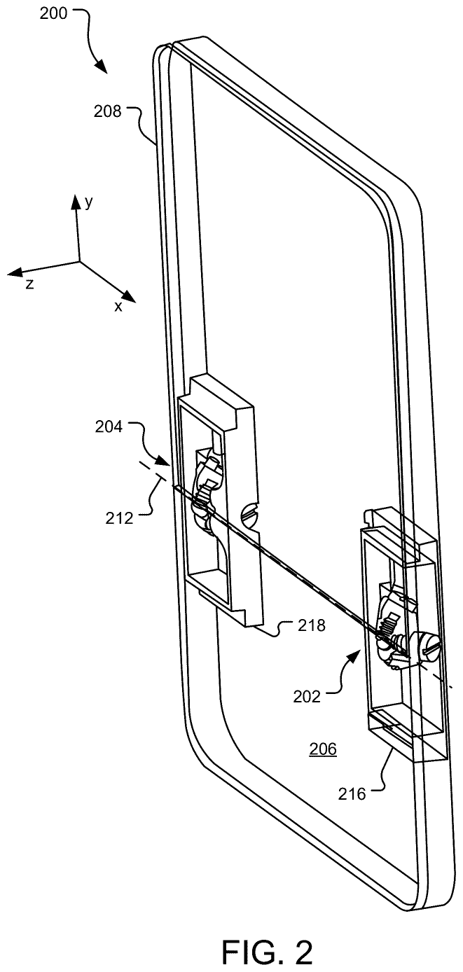

The operating range of the hinges 102, 104 includes a fully open or deployed orientation, as illustrated in FIG. 1 to a fully stowed or closed orientation, as illustrated in FIG. 2 and discussed in detail below. The depicted fully open or deployed orientation is specifically where the kickstand 108 is oriented at a maximum obtuse angle with reference to the tablet 106, which may position the kickstand 108 projecting away from the tablet 106 at up to 170-degrees away from its fully stowed or closed orientation. The hinges 102, 104 may thus have up to a nearly 180-degree operating range or range of motion (e.g., greater than 150-degrees). Other implementations, such as those of a laptop computer instead of the depicted tablet 106 and kickstand 108 may have a greater or lesser operating range than that described above. The disclosed nearly 180-degree operating range is technically advantageous in that it allows for more flexible uses of the device 100, particularly when compared to kickstands or other hinged components with a smaller operating range.

In various implementations, the hinges 102, 104 are extremely small in z-direction height (also referred to as overall thickness) within their respective frames 116, 118 due to packaging requirements in the device 100. For example, the hinges 102, 104 may each be less than 4.0 mm in z-direction height, 8-11 mm in x-direction width, and 10-22 mm in y-direction length. Dimensions of the hinges 102, 104 are flexible and may range widely from the foregoing depending upon the device 100 dimensions and constraints.

The tablet 106 is depicted as a tablet computer, however, the hinges 102, 104 may be similarly incorporated within a variety of computing devices, including mobile computing devices, such as laptop computers, and desktop computing devices. Further, while the tablet 106 and the kickstand 108 are illustrated, and discussed in detail herein, the hinges 102, 104 may be used to hingedly connect any two components (e.g., a keyboard, a display, a touchscreen, a touchpad, a kickstand, a screen cover, and combinations thereof) for a computing device or other type of hinged device. For example, another computing device may be a 2-screen device and the hinges 102, 104 may permit the 2-screen computing device to lay flat where the hinges 102, 104 are oriented at 180-degrees and present the screens in close proximity to one another with only a small front gap or no front gap therebetween. In still further implementations, the kickstand 108 may be replaced with another hinged accessory for a computing device. Finally, the hinges 102, 104 may also be used with similar effect in other devices with hinged components that are not computing devices.

FIG. 2 illustrates a rear perspective view of an example computing device 200 including an integral kickstand 208 stowed against a tablet 206 and connected to the tablet 206 using a pair of multi-axis pin joint hinges 202, 204. The hinges 202, 204 each pivotally connect the tablet 206 (or a first device component) with the integral kickstand 208 (or a second device component) of the device 200. As a result, a user may position the kickstand 208 at a variety of angles with respect to the tablet 206, including a 0-degree angle where the kickstand 208 is stowed against the tablet 206 when not in use, as depicted in FIG. 2. The kickstand 208 is illustrated as transparent and a rear cover of the tablet 206 is omitted to better illustrate the hinges 202, 204.

The hinges 202, 204 each include a trio of pin joints that connect first and second links to the tablet 206 and the kickstand 208. Pivot axes corresponding to each of the pin joints intersect at a point coincident with rotation axis 212. The rotation axis 212 represents the instant center of the hinges 202, 204, which may project in free space between the tablet 206 and the kickstand 208. As each pin joint rotates through the range of motion of the hinges 202, 204, the pivot axes all remain intersecting on a point coincident with the rotation axis 212. As a result, the rotation axis 212 remains in a fixed position and a hinge gap between the tablet 206 and the integral kickstand 208 is consistent throughout the range of motion of the hinges 202, 204.

In various implementations herein, the hinges 202, 204 are referred to separately as hinges or collectively as a singular hinge. The hinges 202, 204 are connected to the tablet 206 at frames 216, 218, respectively, each of which also serves as a cavity in the tablet 206 that houses and conceals the hinges 202, 204 beneath the kickstand 208. Other implementations may omit the frames 216, 218 and instead connect the hinges 202, 204 directly to the tablet 206. There still may be cavities in the tablet 206 to house the hinges 202, 204 in the absence of the frames 216, 218.

The hinges 202, 204 each only partially constrains motion of the kickstand 208 to rotation about the rotation axis 212 extending in the x-direction. In combination the hinges 202, 204 fully constrain motion of the kickstand 208 to rotation about the rotation axis 212 only. Other implementations may use more than the two hinges 202, 204, but only one of the hinges 202, 204 may yield an under constrained system.

The operating range of the hinges 202, 204 includes a fully open or deployed orientation, as illustrated in FIG. 1 to a fully stowed or closed orientation, as illustrated in FIG. 2. The depicted fully stowed or closed orientation is specifically where the kickstand 208 overlies the tablet 206 with as little as a 0-degree angle therebetween. The hinges 202, 204 may thus have up to a nearly 180-degree operating range or range of motion (e.g., 0 -170 degrees).

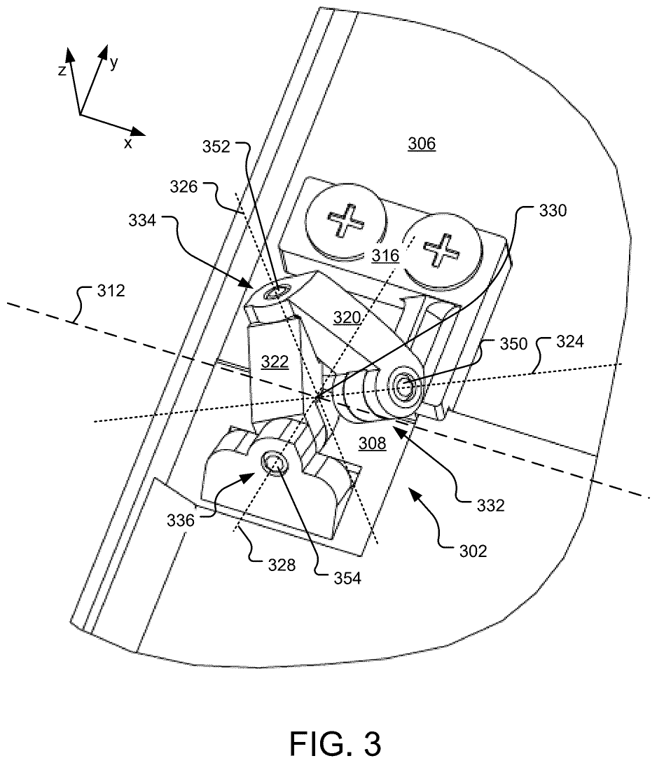

FIG. 3 illustrates a perspective view of an example multi-axis pin joint hinge 302. The hinge 302 pivotally connects a first device component 306 (e.g., a tablet) with a second device component 308. For illustration purposes, front-facing portions of the first device component 306 are omitted as they that would otherwise conceal the hinge 302 as viewed from within the first hinged component 306 in FIG. 3.

The hinge 302 includes a trio of pin joints 332, 334, 336 that connect first and second links 320, 322 to the first device component 306 and the second device component 308. Pivot axes 324, 326, 328 corresponding to each of the pin joints 332, 334, 336, respectively, intersect at a point 330 coincident with rotation axis 312. The rotation axis 312 represents the instant center of the hinge 302, which may project in free space between the first and second device components 306, 308.

More specifically, a first pin joint 332 connects the first link 320 to the first device component 306 (here, via frame 316, discussed below) using pin 350. The first pin joint 332 is rotatable about the first pivot axis 324. A second pin joint 334 connects the first link 320 to the second link 322 using pin 352. The second pin joint 334 is rotatable about the second pivot axis 326. The third pin joint 336 connects the second link 322 to the second device component 308 using pin 354. The third pin joint 336 is rotatable about the third pivot axis 328. The hinge 302 permits the first device component 306 to rotate relative to the second device component 308 (or vice versa) about the rotation axis 312.

As each of the pin joints 332, 334, 336 rotate through the range of motion of the hinge 302, the first, second, and third pivot axes 324, 326, 328 all remain intersecting with the point 330, which is coincident with the rotation axis 312. As a result, the rotation axis 312 remains in a fixed position and a hinge gap between the first and second device components 306, 308 is consistent throughout the range of motion of the hinge 302.

The hinge 302 is connected to the first device component 306 at the frame 316, which also serves as a cavity in the first device component 306 that houses and conceals the hinge 302 beneath the second device component 308. The frame 316 extends around the first and the second links 320, 322 and is embedded within the first device component 306. The frame 316 encompasses all or a portion of the first and the second links 320, 322 throughout a range of rotation of the hinge 302. For example, in a fully deployed orientation, the frame 316 may encompass most of the first link 320 and none of the second link 322, while in a fully stowed orientation, the frame 316 may encompass most or all of the first and the second links 320, 322.

The first and the second links 320, 322 are nested within the frame 316 in a manner where the frame 316 may encompass most or all of the first and the second links 320, 322, at least the fully stowed orientation for packaging reasons. This is technically advantageous in that by encompassing most or all of the first and the second links 320, 322, in the fully stowed orientation, the second device component 308 may lie flush with the first device component 306. Other implementations of the hinge 302 may position the first and the second links 320, 322, and corresponding pin joints 332, 334, 336 in a different manner that does not similarly nest. This can be functionally similar so long as the first, second, and third pivot axes 324, 326, 328 all remain intersecting with the point 330, which is coincident with the rotation axis 312. Still other implementations may omit the frame 316 and instead connect the hinge 302 directly to the first device component 306. There still may be a cavity in the first device component 306 to house the hinge 302 in the absence of the frame 316.

A coefficient of friction (static and/or dynamic) for each of the pin joints 332, 334, 336 defines the overall resistance to rotation of the hinge 302 about the rotation axis 312. More specifically, cumulative friction for interfaces between the first device component 306 and the first link 320, the first link 320 and the second link 322, and the second link 322 and the second device component 308, and their corresponding pins (e.g., pin 350, defines the resistance to rotation of the hinge 302 overall. These coefficients of friction may be carefully designed to yield a desired overall resistance to rotation of the hinge 302 to achieve design objectives, including long-term reliability and performance.

The hinge 302 only partially constrains motion of the second device component 308 with respect to the first device component 306 to rotation about the rotation axis 312 extending in the x-direction. Absent a second or more hinges, or another constraining device, the second device component 308 is free to rotate about the pivot axis 328 independent of the motion of the remaining portions of the hinge 302. A second similar hinge to hinge 302 may be included along the rotation axis 312 to fully constrain motion of the second device component 308 with respect to the first device component 306 to rotation about the rotation axis 312 only. Other implementations may use more than the two hinges, but use of the hinge 302 alone may yield an under constrained system.

In implementations with a second hinge similar to hinge 302, a fourth pin joint connects a third link to the first device component 306 (in some implementations, via a second frame). The fourth pin joint is rotatable about a fourth pivot axis. A fifth pin joint connects the third link to a fourth link. The fifth pin joint is rotatable about a fifth pivot axis. A sixth pin joint connects the fourth link to the second device component 308. The sixth pin joint is rotatable about a sixth pivot axis. The second hinge, similar to the hinge 302, permits the first device component 306 to rotate relative to the second device component 308 (or vice versa) about the rotation axis 312.

As each of the fourth, fifth, and sixth pin joints rotate through the range of motion of the second hinge, the fourth, fifth, and sixth pivot axes all remain intersecting with another point coincident with the rotation axis 312. The first, second, third, fourth, fifth, and sixth pin joints in combination constrain motion of the first device component 306 relative to the second device component 308 to rotation about the rotation axis 312. The intersections of the first, second, and third pivot axes 324, 326, 328 at the first point 330 on the rotation axis 312 and the intersection of the fourth, fifth, and sixth pivot axes at the second point on the rotation axis 312 are fixed in location on the rotation axis 312 throughout a range of rotation of the hinges (or collectively, hinge).

As a result, the rotation axis 312 remains in a fixed position and a hinge gap between the first and second device components 306, 308 is consistent throughout the range of motion of both hinges, operating in unison. In various implementations, the second hinge may be a copy or mirror image of the hinge 302, or a different type of hinge altogether that is limited to rotation about the rotation axis 312.

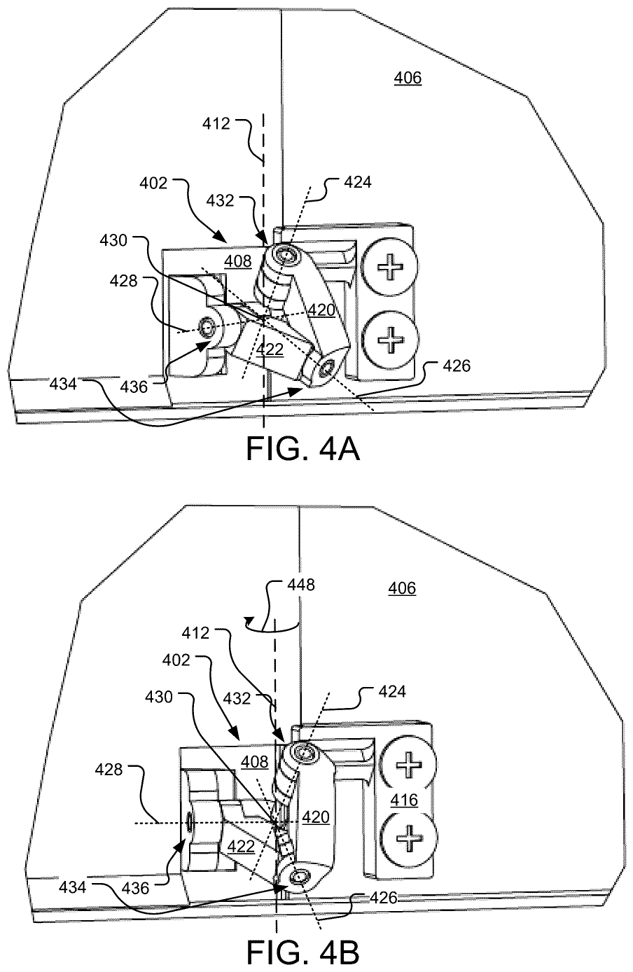

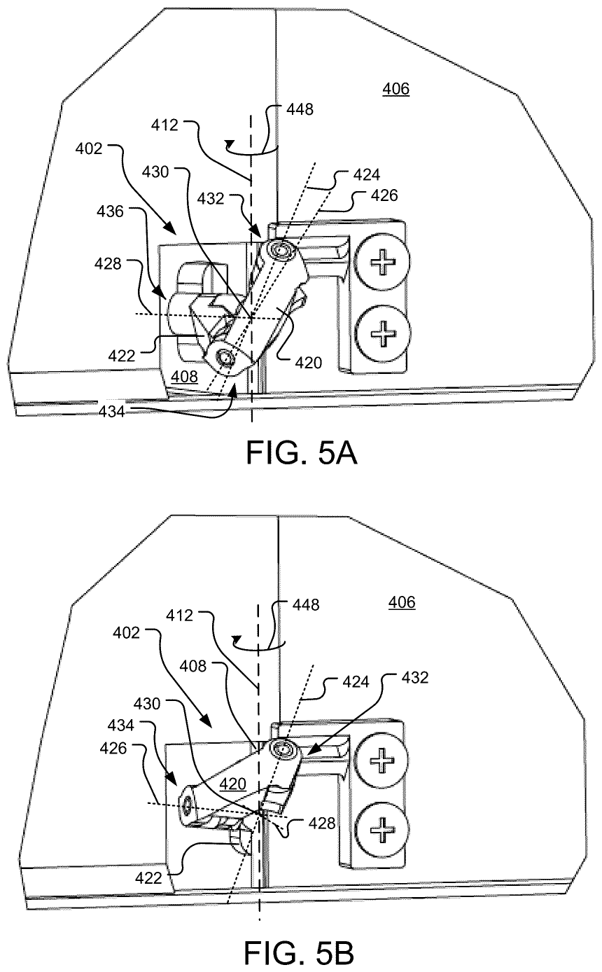

FIG. 4A illustrates a perspective view of an example multi-axis pin joint hinge 402 in a fully closed orientation. The hinge 402 is one of one or more hinges that pivotally connect a first hinged component 406 (e.g., a tablet) with a second hinged component 408 (e.g., a kickstand). For illustration purposes, front-facing portions of the first hinged component 406 are omitted as they that would otherwise conceal the hinge 402 as viewed from within the first hinged component 406 in FIGS. 4A-5B.

The hinge 402 includes a trio of pin joints 432, 434, 436 that connect first and second links 420, 422 to the first hinged component 406 and the second hinged component 408. Pivot axes 424, 426, 428 corresponding to each of the pin joints 432, 434, 436, respectively, intersect at a point 430 coincident with rotation axis 412. The rotation axis 412 represents the instant center of the hinge 402, which may project in free space between the first and second hinged components 406, 408. As each of the pin joints 432, 434, 436 rotate through the range of motion of the hinge 402, the first, second, and third pivot axes 424, 426, 428 all remain intersecting with the point 430, which is coincident with the rotation axis 412. As a result, the rotation axis 412 remains in a fixed position and a hinge gap between the first and second hinged components 406, 408 is consistent throughout the range of motion of the hinge 402.

The hinge 402 is connected to the first hinged component 406 at frame 416, which also serves as a cavity in the first hinged component 406 that houses and conceals the hinge 402 beneath the second hinged component 408. The frame 416 encompasses all or a portion of the first and the second links 420, 422 throughout a range of rotation of the hinge 402. For example, in the depicted fully stowed orientation, the frame 416 encompasses most or all of the first and the second links 420, 422. Other implementations may omit the frame 416 and instead connect the hinge 402 directly to the first hinged component 406. There still may be a cavity in the first hinged component 406 to house the hinge 402 in the absence of the frame 416. A second similar hinge to hinge 402 may be included along the rotation axis 412 to fully constrain motion of the second hinged component 408 with respect to the first hinged component 406 to rotation about the rotation axis 412 only. Other implementations may use more than the two hinges, but use of the hinge 402 alone may yield an under constrained system.

The operating range of the hinge 402 includes a fully stowed or closed orientation, as illustrated in FIG. 4A; to a mostly stowed or closed orientation, as illustrated in FIG. 4B; to a mostly open or deployed orientation, as illustrated in FIG. 5A; to a fully open or deployed orientation, as illustrated in FIG. 5B; and all orientations therebetween. The fully stowed or closed orientation depicted in FIG. 4A is specifically where the second hinged component 408 overlies the first hinged component 406 with as little as a 0-degree angle therebetween.

FIG. 4B illustrates the example multi-axis pin joint hinge 402 of FIG. 4A in a mostly closed orientation. As the second hinged component 408 is rotated away from the first hinged component 406 about the rotation axis 412, as illustrated by arrow 448, each of the pin joints 432, 434, 436 and first and second links 420, 422 move and their respective pivot axes 424, 426, 428 are redirected, but all continue to intersect the rotation axis 412 at the point 430. If the hinge 402 has a nearly 180-degree operating range or range of motion (e.g., greater than 150-degrees), the mostly closed orientation of FIG. 4B may be considered approximately 30-degrees open.

FIG. 5A illustrates the example multi-axis pin joint hinge 402 of FIG. 4A in a mostly open orientation. As the second hinged component 408 is further rotated away from the first hinged component 406 about the rotation axis 412, as illustrated by arrow 448, each of the pin joints 432, 434, 436 and first and second links 420, 422 move and their respective pivot axes 424, 426, 428 are redirected, but all continue to intersect the rotation axis 412 at the point 430. If the hinge 402 has a nearly 180-degree operating range or range of motion (e.g., greater than 150-degrees), the mostly open orientation of FIG. 5B may be considered approximately 60-degrees open.

FIG. 5B illustrates the example multi-axis pin joint hinge 402 of FIG. 4A in a fully open orientation. As the second hinged component 408 is further rotated away from the first hinged component 406 about the rotation axis 412, as illustrated by arrow 448, each of the pin joints 432, 434, 436 and first and second links 420, 422 move and their respective pivot axes 424, 426, 428 are redirected, but all continue to intersect the rotation axis 412 at the point 430. The pin joint 436 is fully hidden from view in FIG. 5B, but the corresponding pivot axis 428 is illustrated to show that it continues to intersect the rotation axis 412 at the point 430. If the hinge 402 has a nearly 180-degree operating range or range of motion (e.g., greater than 150-degrees), the fully open orientation of FIG. 5B may be considered in excess of 90-degrees open.

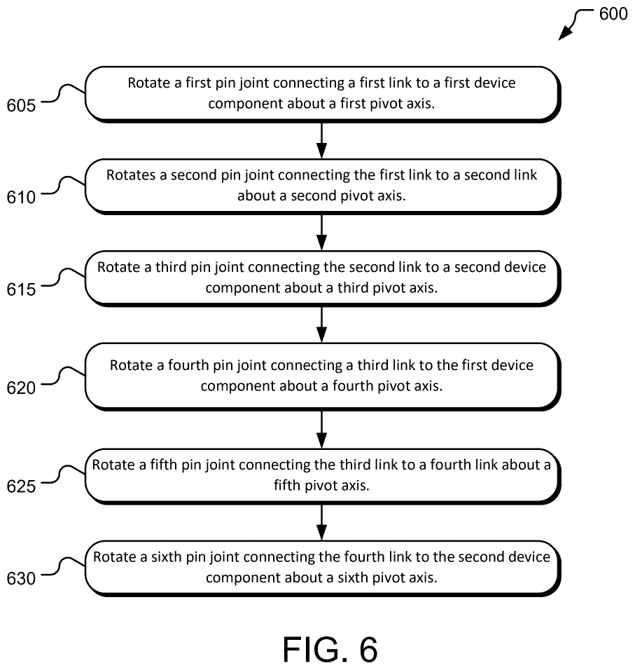

FIG. 6 illustrates example operations 600 for using a multi-axis pin joint hinge. The operations 600 are used to rotate a first device component (e.g., a kickstand) relative to a second device component (e.g., a tablet or screen) of a computing device about a rotation axis using the multi-axis pin joint hinge.

A first rotating operation 605 rotates a first pin joint connecting a first link to the first device component about a first pivot axis. A second rotating operation 610 rotates a second pin joint connecting the first link to a second link about a second pivot axis. A third rotating operation 615 rotates a third pin joint connecting the second link to the second device component about a third pivot axis. The first, second, and third pivot axes intersect at a first point on the rotation axis. As each of the first, second, and third pin joints rotate through the range of motion of the hinge, the first, second, and third pivot axes all remain intersecting with the first point, which is coincident with the rotation axis. As a result, the rotation axis remains in a fixed position and a hinge gap between the first and second device components is consistent throughout the range of motion of the hinge.

The foregoing only partially constrains motion of the second device component with respect to the first device component to rotation about the rotation axis. Additional pin joints, discussed below, which may be referred to herein as a second hinge or part of an overall combined hinge are used to fully constrain motion of the second device component with respect to the first device component to rotation about the rotation axis only.

A fourth rotating operation 620 rotates a fourth pin joint connecting a third link to the first device component about a fourth pivot axis. A fifth rotating operation 625 rotates a fifth pin joint connecting the third link to a fourth link about a fifth pivot axis. A sixth rotating operation 630 rotates a sixth pin joint connecting the fourth link to the second device component about a sixth pivot axis. The fourth, fifth, and sixth pivot axes intersect at a second point on the rotation axis. A combination of all rotating operations 605, 610, 615, 620, 625, 630 occurring simultaneously rotates the first device component relative to the second device component exclusively about the rotation axis.

In various implementations, a cavity may be machined out of or molded within the first device component and may lie between two or more planar layers of the first device component. The cavity may or may not include a frame that serves to attach the hinge to the first device component. Components of each of the pin joints (e.g., device components, links, and pins) may be formed from various rigid metals or plastics. Further, these components may be formed using any applicable manufacturing method for rigid metals or plastics (e.g., injection molding, other molding techniques, extruding, casting, stamping, and so on).

The logical operations making up the embodiments of the presently disclosed technology described herein may be referred to variously as operations, steps, objects, or modules and may be performed in any order, adding or omitting operations as desired, unless explicitly claimed otherwise or a specific order is inherently necessitated by the claim language. Unless otherwise explicitly defined, dimensions described as substantially or approximately herein are +/−10% of the values provided.

Implementations disclosed herein include a multi-axis pin joint hinge comprising a first link; a second link; a first pin joint connecting the first link to a first hinged component, the first pin joint rotatable about a first pivot axis; a second pin joint connecting the first link to the second link, the second pin joint rotatable about a second pivot axis; and a third pin joint connecting the second link to a second hinged component, the third pin joint rotatable about a third pivot axis. The hinge permits the first hinged component to rotate relative to the second hinged component about a rotation axis, wherein the first, second, and third pivot axes intersect at a first point on the rotation axis.

The multi-axis pin joint hinge may further comprise a frame extending around the first link and the second link and embedded within the first hinged component. The frame may encompass all or a portion of the first link and the second link throughout a range of rotation of the multi-axis pin joint hinge.

The multi-axis pin joint hinge may further comprise a third link; a fourth link; a fourth pin joint connecting the third link to the first hinged component, the fourth pin joint rotatable about a fourth pivot axis; a fifth pin joint connecting the third link to the fourth link, the fifth pin joint rotatable about a fifth pivot axis; and a sixth pin joint connecting the fourth link to the second hinged component, the sixth pin joint rotatable about a sixth pivot axis, wherein the fourth, fifth, and sixth pivot axes intersect at a second point on the rotation axis.

The first, second, third, fourth, fifth, and sixth pin joints in combination may constrain motion of the first hinged component relative to the second hinged component to rotation about the rotation axis.

The intersection of the first, second, and third pivot axes at the first point on the rotation axis and the intersection of the fourth, fifth, and sixth pivot axes at the second point on the rotation axis may be fixed in location on the rotation axis throughout a range of rotation of the multi-axis pin joint hinge.

Cumulative friction from interfaces between the first link, the second link, the first hinged component, the second hinged component, and corresponding pins may define an overall resistance to rotation of the hinge.

The first and the second hinged components may be computing device components.

In a fully closed orientation, the second hinged component may overlie the first hinged component.

The first hinged component may have an at least 150-degree rotational range of motion with reference to the second hinged component.

Implementations disclosed herein further include a method of rotating a first device component relative to a second device component of a computing device about a rotation axis using a multi-axis pin joint hinge. The method may comprise rotating a first pin joint connecting a first link to the first device component about a first pivot axis; rotating a second pin joint connecting the first link to a second link about a second pivot axis; and rotating a third pin joint connecting the second link to the second device component about a third pivot axis, wherein the first, second, and third pivot axes intersect at a first point on the rotation axis.

The method may further comprise rotating a fourth pin joint connecting a third link to the first device component about a fourth pivot axis; rotating a fifth pin joint connecting the third link to a fourth link about a fifth pivot axis; and rotating a sixth pin joint connecting the fourth link to the second device component about a sixth pivot axis, wherein the fourth, fifth, and sixth pivot axes intersect at a second point on the rotation axis.

Implementations disclosed herein further include a computing device comprising a first device component, a second device component, and a first hinge connecting the first device component to the second device component. The first hinge permits the first device component to rotate relative to the second device component about a rotation axis. The first hinge includes a first link; a second link; a first pin joint connecting the first link to the first device component, the first pin joint rotatable about a first pivot axis; a second pin joint connecting the first link to the second link, the second pin joint rotatable about a second pivot axis; and a third pin joint connecting the second link to the second device component, the third pin joint rotatable about a third pivot axis, wherein the first, second, and third pivot axes intersect at a first point on the rotation axis.

The computing device may further comprise a frame extending around the first link and the second link and embedded within the first device component. The frame may encompass all or a portion of the first link and the second link throughout a range of rotation of the first hinge.

The computing device may further comprise a second hinge connecting the first device component to the second device component. The second hinge also may permit the first device component to rotate relative to the second device component about the rotation axis. The second hinge may include a third link; a fourth link; a fourth pin joint connecting the third link to the first device component, the fourth pin joint rotatable about a fourth pivot axis; a fifth pin joint connecting the third link to the fourth link, the fifth pin joint rotatable about a fifth pivot axis; and a sixth pin joint connecting the fourth link to the second device component, the sixth pin joint rotatable about a sixth pivot axis, wherein the fourth, fifth, and sixth pivot axes intersect at a second point on the rotation axis.

The second hinge may be one of a copy and a mirror image of the first hinge.

The first, second, third, fourth, fifth, and sixth pin joints in combination may constrain motion of the first device component relative to the second device component to rotation about the rotation axis.

The intersection of the first, second, and third pivot axes at the first point on the rotation axis and the intersection of the fourth, fifth, and sixth pivot axes at the second point on the rotation axis may be fixed in location on the rotation axis throughout a range of rotation of the first and the second hinges.

The first device component may be a tablet computer, and the second device component may be a kickstand for the tablet computer.

The first device component may have an at least 150-degree rotational range of motion with reference to the second device component.

In a fully closed orientation, the second device component may overlie the first device component.

The above specification, examples, and data provide a complete description of the structure and use of exemplary implementations. Since many implementations can be made without departing from the spirit and scope of the presently disclosed technology, the scope resides in the claims hereinafter appended. Furthermore, structural features of the different implementations may be combined in yet another implementation without departing from the recited claims.

What is claimed is:

1. A multi-axis pin joint hinge comprising:
a first link;
a second link;
a first pin joint connecting the first link to a first hinged component, the first pin joint rotatable about a first pivot axis;
a second pin joint connecting the first link to the second link, the second pin joint rotatable about a second pivot axis; and
a third pin joint connecting the second link to a second hinged component, the third pin joint rotatable about a third pivot axis, the hinge to permit the first hinged component to rotate relative to the second hinged component about a rotation axis, wherein the first, second, and third pivot axes intersect at a first point on the rotation axis.

2. The multi-axis pin joint hinge of claim 1, further comprising:
a frame extending around the first link and the second link and embedded within the first hinged component, wherein the frame is to encompass all or a portion of the first link and the second link throughout a range of rotation of the multi-axis pin joint hinge.

3. The multi-axis pin joint hinge of claim 1, further comprising:
a third link;
a fourth link;
a fourth pin joint connecting the third link to the first hinged component, the fourth pin joint rotatable about a fourth pivot axis;
a fifth pin joint connecting the third link to the fourth link, the fifth pin joint rotatable about a fifth pivot axis; and
a sixth pin joint connecting the fourth link to the second hinged component, the sixth pin joint rotatable about a sixth pivot axis, wherein the fourth, fifth, and sixth pivot axes intersect at a second point on the rotation axis.

4. The multi-axis pin joint hinge of claim 3, wherein the first, second, third, fourth, fifth, and sixth pin joints in combination constrain motion of the first hinged component relative to the second hinged component to rotation about the rotation axis.

5. The multi-axis pin joint hinge of claim 3, wherein the intersection of the first, second, and third pivot axes at the first point on the rotation axis and the intersection of the fourth, fifth, and sixth pivot axes at the second point on the rotation axis are fixed in location on the rotation axis throughout a range of rotation of the multi-axis pin joint hinge.

6. The multi-axis pin joint hinge of claim 1, wherein cumulative friction from interfaces between the first link, the second link, the first hinged component, the second hinged component, and corresponding pins defines an overall resistance to rotation of the hinge.

7. The multi-axis pin joint hinge of claim 1, wherein the first and the second hinged components are computing device components.

8. The multi-axis pin joint hinge of claim 1, wherein in a fully closed orientation, the second hinged component overlies the first hinged component.

9. The multi-axis pin joint hinge of claim 1, wherein the first hinged component has an at least 150-degree rotational range of motion with reference to the second hinged component.

10. A method of rotating a first device component relative to a second device component of a computing device about a rotation axis using a multi-axis pin joint hinge comprising:
rotating a first pin joint connecting a first link to the first device component about a first pivot axis;
rotating a second pin joint connecting the first link to a second link about a second pivot axis; and
rotating a third pin joint connecting the second link to the second device component about a third pivot axis, wherein the first, second, and third pivot axes intersect at a first point on the rotation axis.

11. The method of claim 10, further comprising:
rotating a fourth pin joint connecting a third link to the first device component about a fourth pivot axis;
rotating a fifth pin joint connecting the third link to a fourth link about a fifth pivot axis; and
rotating a sixth pin joint connecting the fourth link to the second device component about a sixth pivot axis, wherein the fourth, fifth, and sixth pivot axes intersect at a second point on the rotation axis.

12. A computing device comprising:
a first device component;
a second device component; and
a first hinge connecting the first device component to the second device component, the first hinge to permit the first device component to rotate relative to the second device component about a rotation axis, the first hinge including:
a first link;
a second link;
a first pin joint connecting the first link to the first device component, the first pin joint rotatable about a first pivot axis;
a second pin joint connecting the first link to the second link, the second pin joint rotatable about a second pivot axis; and
a third pin joint connecting the second link to the second device component, the third pin joint rotatable about a third pivot axis, wherein the first, second, and third pivot axes intersect at a first point on the rotation axis.

13. The computing device of claim 12, further comprising:
a frame extending around the first link and the second link and embedded within the first device component, wherein the frame is to encompass all or a portion of the first link and the second link throughout a range of rotation of the first hinge.

14. The computing device of claim 12, further comprising:
a second hinge connecting the first device component to the second device component, the second hinge also to permit the first device component to rotate relative to the second device component about the rotation axis, the second hinge including:
a third link;
a fourth link;
a fourth pin joint connecting the third link to the first device component, the fourth pin joint rotatable about a fourth pivot axis;
a fifth pin joint connecting the third link to the fourth link, the fifth pin joint rotatable about a fifth pivot axis. and
a sixth pin joint connecting the fourth link to the second device component, the sixth pin joint rotatable about a sixth pivot axis, wherein the fourth, fifth, and sixth pivot axes intersect at a second point on the rotation axis.

15. The computing device of claim 14, wherein the second hinge is one of a copy and a mirror image of the first hinge.

16. The computing device of claim 14, wherein the first, second, third, fourth, fifth, and sixth pin joints in combination constrain motion of the first device component relative to the second device component to rotation about the rotation axis.

17. The computing device of claim 14, wherein the intersection of the first, second, and third pivot axes at the first point on the rotation axis and the intersection of the fourth, fifth, and sixth pivot axes at the second point on the rotation axis are fixed in location on the rotation axis throughout a range of rotation of the first and the second hinges.

18. The computing device of claim 12, wherein the first device component is a tablet computer, and the second device component is a kickstand for the tablet computer.

19. The computing device of claim 12, wherein the first device component has an at least 150-degree rotational range of motion with reference to the second device component.

20. The computing device of claim 12, wherein in a fully closed orientation, the second device component overlies the first device component.
